(19) United States
(12) Patent Application Publication
(10) Pub. No.: US 2021/0224014 A1
(43) Pub. Date: Jul. 22, 2021

(54) DISPLAY METHOD, DISPLAY SYSTEM AND VEHICLE

(71) Applicant: Shenzhen Next Generation Communications Limited, Shenzhen (CN)

(72) Inventor: CHEN-FU CUI, Shenzhen (CN)

(21) Appl. No.: 17/154,962

(22) Filed: Jan. 21, 2021

(30) Foreign Application Priority Data
Jan. 21, 2020 (CN) 202010070710.7

(51) Int. Cl. G06F 3/14; G06F 3/147; H04L 29/08; B60K 35/00

(52) U.S. Cl. CPC G06F 3/1423; G06F 3/147; H04L 67/12; H04L 67/141; B60K 2370/1523; B60K 2370/1534; B60K 2370/166; B60K 2370/165; B60K 35/00

(57) ABSTRACT

A display method is implemented in a vehicle comprising multiple display devices. The multiple display devices comprise a master display device and at least one slave display device. The multiple display devices establish a communication network, by which the multiple display devices communicate with each other. The master display device sends cross screen display message to the at least one slave display device, and the cross screen display message comprises target device information and display information. The target device information identifies at least one target display device, and the display information comprises a storage path that stores display contents. The at least one target display device displays the display contents asynchronously.

This application claims priority to Chinese Patent Application No. 202010070710.7 filed on Jan. 21, 2020, the contents of which are incorporated by reference herein.

### FIELD

The subject matter herein generally relates to a vehicle multi-screen control field, especially to a display method, a display system and a vehicle.

### BACKGROUND

Generally, multiple screens of vehicle share contents by a Wi-Fi direct technology or a Digital Living Network Alliance (DLNA) technology to accomplish cross screen display. However, when the Wi-Fi direct technology is used to share display contents from a first screen to a second screen, the display contents are displayed on the first screen and the second screen synchronously, therefore, user's operations from the first screen will affect the display contents of the second screen. When the DLNA technology is used to share the display contents, the shared display contents are only displayed on a screen being shared, and the screen that initiated the shared display contents no longer displaying the shared display contents.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of a display device.

FIG. 2 is a block diagram of an embodiment of multiple display devices communicated with each other.

FIG. 3 is a block diagram of an embodiment of a cross screen display system.

FIG. 4 is a flowchart of an embodiment of a display method.

FIG. 5 is a schematic diagram of establishing a communication network established by the display method of FIG. 4.

FIG. 6 is a flowchart of an embodiment of a slave display device sending cross screen display message to a master display device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

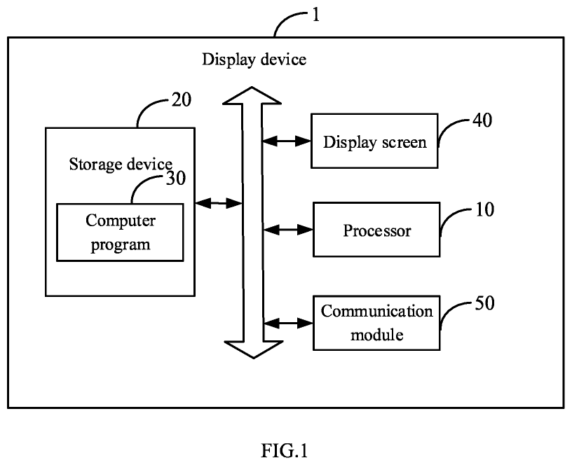

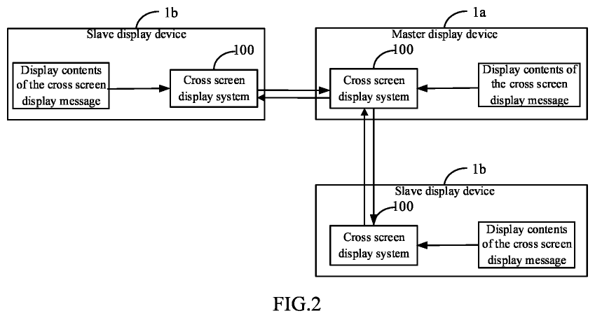

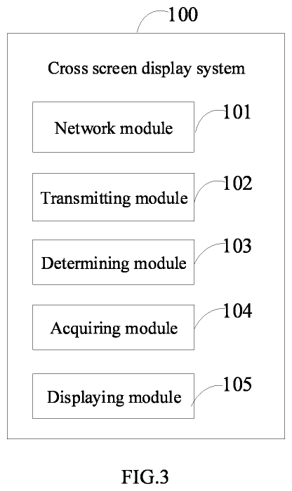

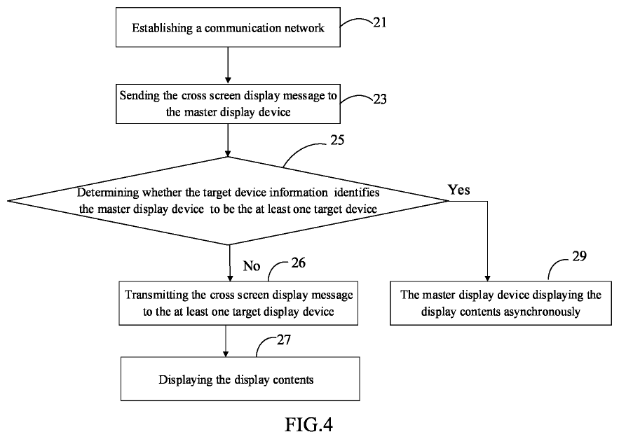

FIG. 1 illustrates a display device 1. The display device 1 includes, but is not limited to a processor 10, a storage device 20, and computer program 30. The computer program 30 are stored in the storage device 20 and performed by the processor 10. The processor 10 performs steps of a display method when performing the computer program 30, for example, steps S21 to S29, as shown in FIG. 4. Alternatively, the function of each module/unit in a cross screen display system when the processor 10 performing the computer program 30, for example, modules 101-105 as shown in FIG. 3. The display device 1 is installed in a vehicle. In one embodiment, the display device 1 has different installation types according to installation location of the display device 1. In one embodiment, the display device 1 includes a master display device 1a and a number of slave display devices 1b (as shown in FIG. 2). The service terminal 1a is set in a main driving seat of the vehicle, and each of the slave display devices 1b is set in a co-pilot seat or a passenger seat of the vehicle.

In one embodiment, the computer program 30 may be divided into one or more modules/units, one or more modules/units are stored in the storage device 20, and performed by the processor 10 to complete the present disclosure. One or more modules/units may be a series of computer program instruction segments capable of performing a specific function, and the instruction segment is used to describe the execution process of the computer program 30 in the display device 1. For example, the computer program 30 may be divided into a network module 101, a transmitting module 102, a determining module 103, a acquiring module 104, and a displaying module 105 (as shown in FIG. 3). The specific functions of each modules 101-105 can be seen in the function of each module in the cross screen display system.

In one embodiment, the display device 1 can be a computer, a server or other computing equipment. Skilled person in the field can understand that FIG. 1 is only an example of the display device 1, does not limit the display device 1, and the display device 1 may include more or less parts than illustration of FIG. 1, or the display device 1 combines certain parts, or different parts, such as the display device 1 may include input and output device, network access equipment, bus, etc.

The processor 10 can be a central processing unit (CPU), or a universal processor, a Digital Signal Processor (DSP), an Application Specific Integrated Circuit (ASIC), a Field-Programmable Gate Array (FPGA), a split door or transistor logic device, a split hardware components, or other programmable logic device. In another embodiment, the processor 10 can be any conventional processor. The processor 10 can also be a control center of the display device 1, using various interfaces and lines to connect the various parts of the display device 1.

In one embodiment, the storage device 20 may be used to store the computer program 30 and/or modules/units, and the processor 10 achieves the various functions of the display device 1 by running or executing the computer program and/or module/unit stored in the storage device 20, and invoking parameters stored in the storage device 20. In one embodiment, the storage device 20 may include a stored program area and a storage parameter area. The stored program area may store an operating system, at least one function applications (such as sound playback function, image playback function, etc.). In one embodiment, the storage device can include a high-speed random access memory, as well as a non-volatile memory such as a hard drive, an internal memory, a plug-in hard drive, a Smart Media Card (SMC), a Secure Digital (SD) card, a Flash Card, at least one disk memory device, a flash memory device, or other volatile solid state memory device.

In one embodiment, the display device 1 further includes a display screen 40 and a communication module 50. The display screen 40 is used to display various data and contents of the display device 1. In one embodiment, The display screen 40 may be a touch screen. The communication module 50 is used to support communication between the display devices 1 in a wired or wireless manner.

FIG. 2 illustrates communication between multiple display devices 1. FIG. 3 illustrates the cross screen display system 100. The cross screen display system 100 is applied in the display device 1. In detail, the cross screen display system 100 is applied in the master display device 1a of the display device 1 and the slave display device 1b of the display device 1. The cross screen display system 100 may include several functional modules consisting of program code. The program code in the cross screen display system 100 may be stored in the storage device 20 of the display device 1 and performed by at least one processor 10 in order to realize cross screen display function.

In one embodiment, the cross screen display system 100 may be divided into multiple functional modules. Refer to FIG. 3, the cross screen display system 100 includes a network module 101, a transmitting module 102, a determining module 103, a acquiring module 104, and a displaying module 105. The modules 101-105 of the cross screen display system 100 can be collections of software instructions. In present embodiment, the network module 101, the transmitting module 102, the determining module 103, the acquiring module 104, and the displaying module 105 are stored in the storage device 20 of the display device 20 and executed by the processor 10 of the display deice 20. In another embodiment, the network module 101, the transmitting module 102, the determining module 103, the acquiring module 104, and the displaying module 105 are program instructions or firmware cured in the processor 10.

The network module 101 establishes a wired communication network or a wireless communication network, by which multiple display devices 1 communicate with each other. The transmitting module 102 receives or sends a cross screen display message. In one embodiment, the cross screen display message includes target device information of the cross screen display message and display information. The determining module 103 determines whether the target device information of the cross screen display message identifies or contains the master display device 1a. The acquiring module 104 acquires the display information. The displaying module 105 displays the display information.

FIG. 4 illustrates a flowchart of an embodiment of a display method. The display method is provided by way of example, as there are a variety of ways to carry out the method. The method described below can be carried out using the configurations illustrated in FIGS. 1-3, for example, and various elements of these figures are referenced in explaining the example method. Each block shown in FIG. 4 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example display method can begin at block 21.

At block 21, the network module 101 establishes a communication network, by which multiple display devices 1 communicate with each other. In one embodiment, the communication network is a wired communication network or a wireless communication network, for example, a wireless LAN.

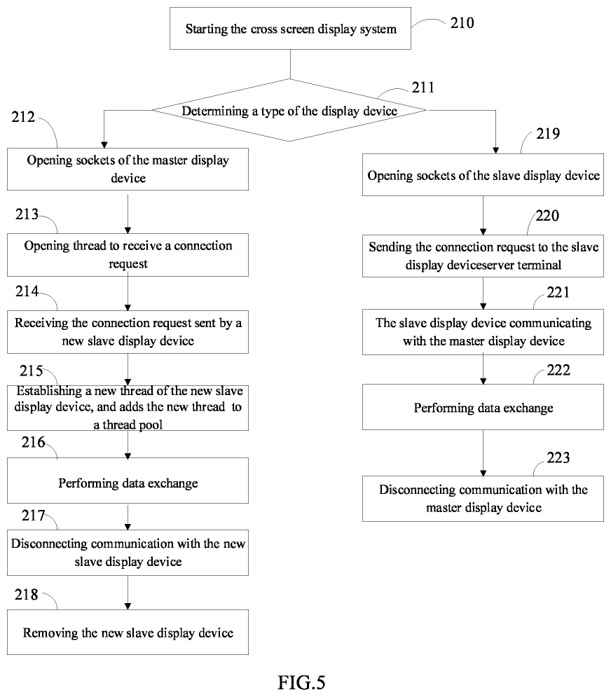

FIG. 5 illustrates establishing the communication network method. The example method can begin at block 210.

At block 210, after the display device 1 is turned on, the cross screen display system 100 is started.

At block 211, the network module 101 determines a type of the display device 1. When the type of the display device 1 is the master display device 1a, block 212 is performed. When the type of the display device 1 is the slave display device 1b, block 219 is performed.

At block 212, the master display device 1a opens sockets of the master display device 1a.

At block 213, the master display device 1a opens thread to receive a connection request sent by the slave display device 1b in a loop.

At block 214, the master display device 1a receives the connection request sent by a new slave display device 1b.

At block 215, the master display device 1a establishes a new thread of the new slave display device 1b, and adds the new thread of the new slave display device 1b to a thread pool in response to the connection request.

At block 216, the master display device 1a communicates with the slave display device 1b by the thread of the slave display device 1b, and performs data transmission.

At block 217, the master display device 1a disconnects communication with the new slave display device 1b when the data transmission between the slave display device 1b and the service terminal 1a is completed.

At block 218, the master display device 1a removes the new slave display device 1b.

At block 219, when the type of the display device 1 is the slave display device 1b, the slave display device 1b opens sockets of the slave display device 1b.

At block 220, the slave display device 1b sends the connection request to the master display device 1a.

At block 221, the slave display device 1b communicates with the master display device 1a in response to the connection request.

At block 222, the slave display device 1b communicates with the master display device 1a and performs data transmission.

At block 223, the slave display device 1b disconnects communication with the master display device 1a when the data transmission between the slave display device 1b and the service terminal 1a is completed.

After the display device 1 establishing the communication network, the network module 101 sets property parameters of the display device 1, and identifies the type of the display device according to the property parameters of the display device 1. In one embodiment, the property parameters include Internet Protocol (IP) address of the display device 1, and the display device 1 identifies the type of the display device according to the IP address. Therefore, the display device 1 can determines the type of the display device 1 according to the property parameters of the display device 1.

At block 23, the transmitting module 102 of the slave display device 1b sends the cross screen display message to the master display device 1a. In one embodiment, the cross screen display message identifies the target device information of the cross screen display message and the display information. In one embodiment, the target device information of the cross screen display message includes at least one target display device to implement cross screen display, and the display information includes a storage path that stores the display information. In one embodiment, the cross screen display message further includes massage type, for example, the massage type can be flying screen broadcast.

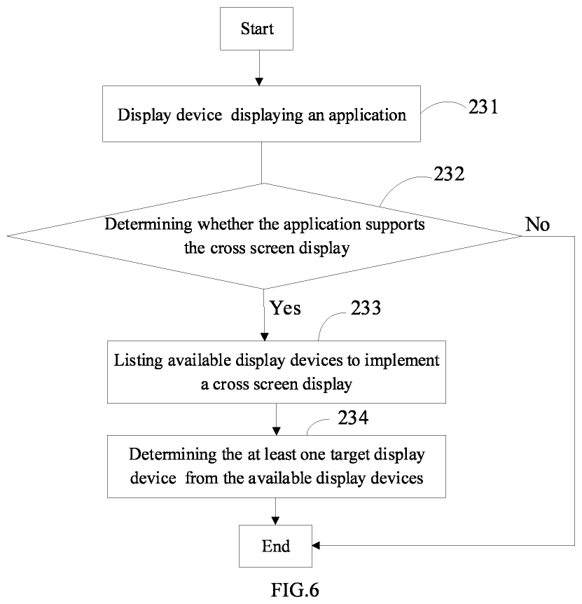

FIG. 6 illustrates a method for the slave display device 1b sending the cross screen display message to the master display device 1a. The example method can begin at block 231.

At block 231, the display device 1 displays an application.

At block 232, the display device 1 determines whether the application supports the cross screen display. When the application supports the cross screen display, block 233 is performed. When the application doesn't support the cross screen display or the display device 1 opens a new application, the block 232 is repeated. The application supporting the cross screen display includes, but is not limited to an audio application, a video application, a news application, a navigation application. In one embodiment, the application supporting the cross screen display can be set in the display device 1. In one embodiment, the cross screen display message further includes message name. The message name can be application name, for example, the message name can be music, video, news, and navigation.

In one embodiment, the display information further includes target contents associates with the display information to implement cross screen display. For example, the target contents may be cover information related to music or video, or a summary of news, so that users can quickly understand the target device information.

At block 233, the display device 1 lists available display devices to implement a cross screen display.

In one embodiment, the display device 1 lists available display devices to implement a cross screen display, displays label numbers of the available display devices, and generates virtual buttons corresponding to the available display devices so that the user can select the display device 1 by the virtual buttons.

At block 234, the display device 1 determines the at least one target display device from the available display devices, and generates the target device information and the display information of the cross screen display message corresponding to the at least one target display device.

In one embodiment, the display device 1 receive user's pressing operation on the virtual button, for example, clicking the virtual buttons to determine the at least one target display device.

At block 25, the transmission module 102 of the master display device 1a receives the cross screen display message, and the determining module 103 determines whether the target device information of the cross screen display message identifies the master display device 1a to be the at least one target device. When the target device information of the cross screen display message identifies the at least one slave display device to be the at least one target display device, block 26 is performed, and when the target device information identifies the master display device to be the at least one target display device, block 29 is performed.

At block 26, the transmission module 102 of the master display device 1a transmits the cross screen display message to the at least one target display device that included in the target device information of the cross screen display message.

At block 27, the acquiring module 104 of the at least one target display device that needs the cross screen display acquires the display contents according to the storage path that storing the display information, and the displaying module 105 of the at least one target display device displays the display contents.

In one embodiment, the at least one target display device that needs the cross screen display and the display device 1 that sends the cross screen display message display the display information independently. The display device 1 that sends the cross screen display message can't stop sending the cross screen display message that displayed on the at least one target display device that needs the cross screen display. The at least one target display device that needs the cross screen display and the display device 1 that sends the cross screen display message perform display-related operation independently. In one embodiment, the display-related operation includes playback progress and playback brightness. In one embodiment, when the at least one target display device that needs the cross screen display is in a display state, the display module 105 of the display device 1 displays the display information and original display contents of the display device 1 by splitting display screen of the display device 1.

In one embodiment, the at least one target display device that needs the cross screen display accesses to the display device 1 that sends the cross screen display message by the IP address, the socket, or the storage path of the display device 1 that sends the cross screen display message.

At block 29, the master display device 1 acquires the display information according to the storage path included in the display information, and displays the display contents asynchronously, and performs block 26-27.

In one embodiment, when the master display device 1a sends the display information, the slave display device 1b acquires the display information according to the storage path included in the display information, and displays the display information.

The modules/units of the display device 1 may be stored in a computer-readable storage medium if it is implemented, sold or used in the form of a software function unit as a stand-alone product. The present disclosure may implement all or part of the process in the embodiment method described above, may also be completed by instructing relevant hardware through a computer program. The computer program may be stored in a computer readable storage medium, and the computer program may implement the blocks of the above mentioned method embodiments when executed by the processor 10. The computer program includes computer program code, and the computer program code may be source code form, object code form, executable files or some intermediate form. The computer readable storage medium may include any entities or devices capable of carrying the computer program code, recording media, USB drive, mobile hard disk, disk, computer memory, read-only memory (ROM), random access memory (RAM), carrier signal, telecommunications signal and software distribution media.

The display method, the display device 1 and the vehicle perform cross screen display, multiple display devices 1 can acquire corresponding display information, therefore, display method, the display device 1 and the vehicle can independently display the display information.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A display method implemented in a vehicle comprising a plurality of display devices, the plurality of display devices comprising a master display device and at least one slave display device, the display method comprising:
establishing a communication network, through which the plurality of display devices communicate with each other;
the master display device sending a cross screen display message to the at least one slave display device, the cross screen display message comprising target device information and display information, the target device information identifying at least one target display device to implement a cross screen display, and the display information comprising a storage path that stores display contents;
the at least one target display device displaying the display contents asynchronously.

2. The display method as recited in claim 1, further comprising:
the at least one slave display device sending the cross screen display message to the master display device.

3. The display method as recited in claim 2, further comprising:
when the target device information identifies the at least one slave display device to be the at least one target display device, the master display device transmitting the cross screen display message to the at least one target display device.

4. The display method as recited in claim 2, further comprising:
when the target device information identifies the master display device to be the at least one target display device, the master display device acquiring the display contents according to the storage path and transmitting the cross screen display message to the at least one target display device.

5. The display method as recited in claim 1, further comprising:
determining a type of the target display device;
when the type of the target display device is the master display device,
opening sockets of the master display device; and
opening thread to receive a connection request sent by the at least one slave display device in a loop.

6. The display method as recited in claim 5, further comprising:
receiving a connection request sent by another slave display device;
establishing a new thread of the another slave display device, and
adding the new thread of the another slave display device to a thread pool in response to the connection request.

7. The display method as recited in claim 6, further comprising:
when the type of the target display device is the at least one slave display device,
opening the sockets of the at least one slave display device;
sending the connection request to the master display device; and
communicating with the master display device in response to the connection request.

8. The display method as recited in claim 5, further comprising:
setting property parameters of the target display device; and
identifying the type of the target display device according to the property parameters of the display device, wherein the property parameters comprise Internet Protocol (IP) address of the display device.

9. The display method as recited in claim 1, further comprising:
determining whether an application supports the cross screen display;
when the application supports the cross screen display;
listing available display devices to implement a cross screen display;
determining the at least one target display device from the available display devices, and
generating the target device information and the display information of the cross screen display message corresponding to the at least one target display device.

10. The display method as recited in claim 1, wherein the application supporting the cross screen display is an audio application, a video application, a news application, or a navigation application.

11. A display system, comprising:
multiple display devices comprising a master display device and at least one slave display device;
one or more processors; and
a non-transitory storage medium coupled to the one or more processors and configured to store a plurality of instructions, which causes the one or more processors to:
establish a communication network, by which the multiple display devices communicate with each other;
the master display device send cross screen display message to the at least one slave display device, wherein the cross screen display message comprises target device information and display information, the target device information identifies at least one target display device to implement cross screen display, and the display information comprises a storage path that stores display contents;
the at least one target display device display the display contents asynchronously.

12. The display system as recited in claim 11, wherein the plurality of instructions is further configured to cause the one or more processors to:
the at least one slave display device send the cross screen display message to the master display device.

13. The display system as recited in claim 12, wherein
when the target device information identifies the at least one slave display device to the at least one target display device, the master display device transmits the cross screen display message to the at least one target display device to implement cross screen display.

14. The display system as recited in claim 12, wherein
when the target device information identifies the master display device to be the at least one target display device, the master display device acquires the display contents according to the storage path, and transmit the cross screen display message to the at least one target display device that needs the cross screen display.

15. The display system as recited in claim 11, wherein the plurality of instructions is further configured to cause the one or more processors to:
determine a type of the target display device;
open sockets of the master display device when the type of the target display device is the master display device;
open thread to receive a connection request sent by the at least one slave display device in a loop.

16. The display system as recited in claim 15, wherein the plurality of instructions is further configured to cause the one or more processors to:
receive the connection request sent by a new slave display device;
establish a new thread of the new slave display device, and
add the new thread of the new slave display device to a thread pool in response to the connection request.

17. The display system as recited in claim 16, wherein the plurality of instructions is further configured to cause the one or more processors to:
when the type of the target display device is the at least one slave display device,
open the sockets of the at least one slave display device;
send the connection request to the master display device; and
communicate with the master display device in response to the connection request.

18. The display system as recited in claim 15, wherein the plurality of instructions is further configured to cause the one or more processors to:
set property parameters of the at least one target display device; and
identify the type of the at least one target display device according to the property parameters of the display device, wherein the property parameters comprise Internet Protocol (IP) address of the display device.

19. The display system as recited in claim 11, wherein the plurality of instructions is further configured to cause the one or more processors to:
determine whether an application supports the cross screen display;
when the application supports the cross screen display,
list available display devices to implement a cross screen display;
determine the at least one target display device from the available display devices, and
generate the target device information and the display information of the cross screen display message corresponding to the at least one target display device.

20. A vehicle comprising multiple display devices,
the multiple display devices comprising a master display device and at least one slave display device;
one or more processors;
a non-transitory storage medium coupled to the one or more processors and configured to store a plurality of instructions, which causes the one or more processors to:
establish a communication network, by which the multiple display devices communicate with each other;
the master display device send cross screen display message to the at least one slave display device of the display device, wherein the cross screen display message comprises target device information and display information, the target device information identifies at least one target display device to implement cross screen display, and the display information comprises a storage path that stores display contents;
the at least one target display device display the display contents asynchronously.
